(19) United States
(12) Patent Application Publication
(10) Pub. No.: US 2019/0193451 A1
(43) Pub. Date: Jun. 27, 2019

(54) AUTOMATIC BOOKMARK

(71) Applicant: SUNCO ENGINEER LIMITED, Minamisoma-shi, Fukushima (JP)

(72) Inventor: Harutoshi Ito, Fukushima (JP)

(21) Appl. No.: 16/328,312

(22) PCT Filed: Nov. 14, 2017
(86) PCT No.: PCT/JP2017/040915

§ 371 Date: Feb. 26, 2019

(30) Foreign Application Priority Data
Nov. 15, 2016 (JP) 2016-222435

(51) Int. Cl. B42D 9/02

(52) U.S. Cl. CPC B42D 9/02

(57) ABSTRACT

The automatic bookmark includes a first fixing portion (2) and a second fixing portion (3) to be fixed to the respective front and back covers of a book W or the like; a bookmark portion (6) to be inserted between the closed pages; a first arm portion (4) whose base end is connected to the first fixing portion (2) and leading end is connected to the bookmark portion (6); and a second arm portion (5) whose base end is connected to the second fixing portion (3) and leading end is connected to the bookmark portion (6). A joint portion (11) is provided that connects the leading end of the first arm portion (4) and the leading end of the second arm portion (5). The bookmark portion (6) has a shape whose one end is connected to the joint portion (11) and another end is directed to between the pages.

### TECHNICAL FIELD

The present invention relates to automatic bookmarks.

### BACKGROUND ART

Conventionally, automatic bookmarks have been known that include a first fixing portion to be fixed to the upper edge of the front cover of a book or the like, a second fixing portion to be fixed to the upper edge of the back cover of the book, a bookmark portion to be inserted between the closed pages of the book, and a first arm portion whose base end is connected to the first fixing portion and leading end is connected to the bookmark portion, and a second arm portion whose base end is connected to the second fixing portion and leading end is connected to the bookmark portion (refer to, for example, Patent Document 1 or 2).

An automatic bookmark of this type has a folding line on the leading end portion of the bookmark portion so that the bookmark portion is folded or unfolded along the folding line in conjunction with an opening and closing motion of a book or the like. That is, as the pages of a book or the like are being opened, the distance between the fixing portions becomes longer. Accordingly, the bookmark portion is pulled in the right-left direction to be unfolded along the folding line, so that the bookmark portion becomes substantially flat above between the pages to stay off the pages. As the book is being closed, the distance between the fixing portions becomes shorter. Accordingly, the bookmark portion is folded along the folding line to be inserted between the pages.

### CITATION LIST

### Patent Literature

Patent Literature 1: Registered Utility Model No. 3192906

Patent Literature 2: Japanese Patent Laid-open Publication No. 2008-68609

### SUMMARY OF INVENTION

### Technical Problem

As described above, the bookmark portion of an automatic bookmark having such a conventional structure is unfolded along the folding line above between the pages when the pages of a book or the like are open. Thus, in some cases, if the pages are opened by a small amount or the distance between the pages becomes shorter in the direction in which the pages are closed, for example, when turning the pages, the bookmark portion may be folded halfway to be inserted between the pages. This is bothersome in reading, and inconvenient in that the bookmark portion significantly interferes with the pages, thus inhibiting smooth motion of turning the pages.

In view of the above, the present invention aims to provide an automatic bookmark that lifts a bookmark portion upward relatively largely above between the pages when a book or the like is opened so that interference between the pages and the bookmark portion can be reduced.

### Solution to Problem

In order to achieve the above-described object, an automatic bookmark according to the present invention includes a first fixing portion to be fixed to the upper edge of the front cover of a book or the like; a second fixing portion to be fixed to the upper edge of the back cover of the book; a bookmark portion to be positioned closer to the open side of the book than both of the fixing portions are, and to be inserted between closed pages of the book; a first arm portion whose base end is connected to the first fixing portion and leading end is connected to the bookmark portion; and a second arm portion whose base end is connected to the second fixing portion and leading end is connected to the bookmark portion, wherein in conjunction with separation between the first fixing portion and the second fixing portion, following an opening motion of the book, the first arm portion and the second arm portion swing upward above between open pages of the book, so that the bookmark portion departs from between the pages, in conjunction with approach between the first fixing portion and the second fixing portion, following a closing motion of the book, the first arm portion and the second arm portion swing, so that the bookmark portion is inserted between closed pages, a joint portion is provided that connects the first arm portion and the second arm portion to each other via the respective leading ends of the first arm portion and the second arm portion, and the bookmark portion has a shape whose one end is connected to the joint portion and another end is directed to between the pages of the book.

According to the present invention, one end of the bookmark portion is connected to the joint portion that connects the leading end of the first arm portion and the leading end of the second arm portion. This structure eliminates the need of a folding line marked on the bookmark portion, and thus enables efficient conversion of the opening and closing motion of the pages of a book or the like into a swinging motion of the first arm portion and the second arm portion.

Hence, as compared with a conventional bookmark whose bookmark portion is to be unfolded, the bookmark portion can be lifted upward largely above between the pages. This can reduce the interference between the pages and the bookmark portion when turning the pages. In the above, as the leading end of the bookmark portion has a shape directed to between the pages of the book, and accordingly the bookmark portion extends toward between the pages of the book, the bookmark portion is reliably held between the closed pages even if the joint portion is positioned exposed outside above the book.

Further, according to the present invention, since a folding line for unfolding the bookmark portion is unnecessary to be marked on the bookmark portion, it is possible to select a flat panel member for formation of a bookmark portion. This can provide a higher degree of freedom in designing bookmark portions.

Further, in the present invention, it is preferable that the joint portion be positioned such that the joint portion is exposed outside above the book when the bookmark portion is inserted between the pages of a book or the like.

The distance between the first fixing portion fixed to the front cover and the second fixing portion fixed to the back cover is positioned apart from each other due to the thickness of the book. Hence, the first arm portion and the second arm portion are separated from each other except the joint portion at the leading ends even with the book closed. If the joint portion is inserted and held between the pages with the first and second fixing portions separated from each other as described above, the joint portion may generate a relatively large gap between the pages through the influence of the separation of the first and second arm portions. This results in not only poor appearance but also a large burden on both the arm portions.

On the contrary, according to the present invention, the joint portion is not held between the pages of a book or the like. Hence, the pages are not left widely spaced apart from each other. Further, this structure can reduce a burden on both the arm portions.

In the present invention, it is preferable that the first arm portion and the second arm portion be in a posture extending along the upper edge of the book when the bookmark portion is inserted between the pages of a book or the like. With the above, it is possible to make relatively small the protrusion of both the arm portions from the upper edge of a book or the like when the pages of the book are closed, so that the automatic bookmark attached to the book can be saved from being an obstacle.

Note that books or the like with which an automatic bookmark according to the present invention can be used include books, such as reading materials, magazines, notebooks, diaries, map books, travel catalogues, and cooking books or the like.

### BRIEF DESCRIPTION OF DRAWINGS

FIG. 1 is an explanatory perspective view of an automatic bookmark according to one embodiment of the present invention.

FIG. 2 is an explanatory side view of the automatic bookmark according to this embodiment in use.

FIG. 3 is a plan view of FIG. 2.

FIG. 4 is an explanatory front view of the automatic bookmark according to this embodiment in use.

FIG. 5 is a plan view of FIG. 4.

FIG. 6 is an explanatory diagram explaining a hinge portion formed.

FIG. 7 is a side view of FIG. 4.

FIG. 8 is an explanatory diagram illustrating a modified example of a clip portion.

### DESCRIPTION OF EMBODIMENTS

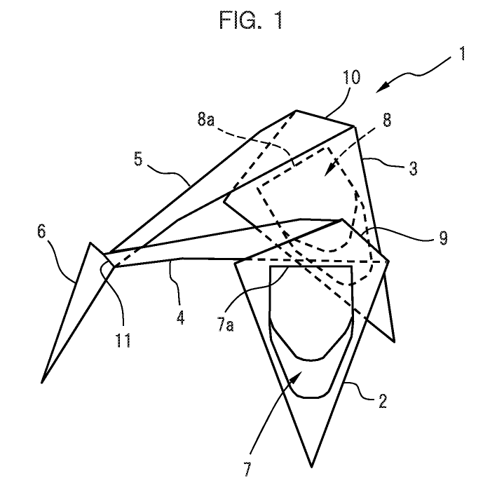

One embodiment of the present invention will be described based on the drawings. An automatic bookmark 1 in this embodiment is made of paperboard and, as illustrated in FIG. 1, has two identically shaped fixing portions (a first fixing portion 2, a second fixing portion 3), two identically shaped arm portions (a first arm portion 4, a second arm portion 5) connected to the respective fixing portions 2, 3, and a single bookmark portion 6 connected to the respective leading ends of the arm portions 4, 5. Although both the fixing portions 2, 3 have the identical shapes in this embodiment, the first fixing portion 2 and the second fixing portion 3 may have different shapes.

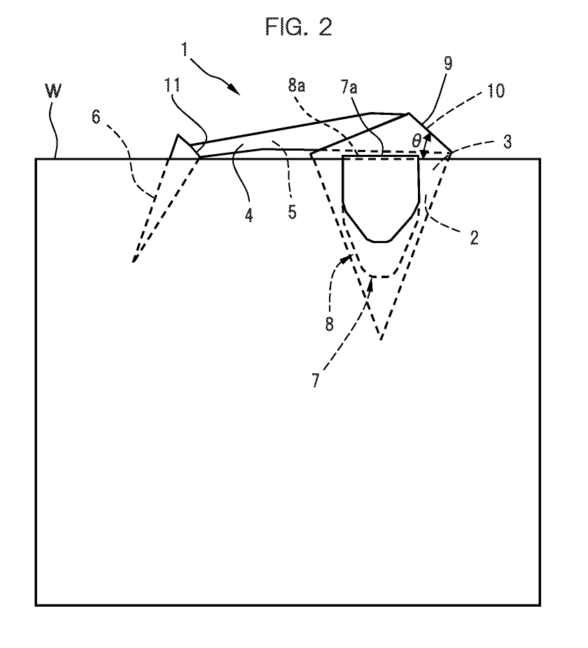

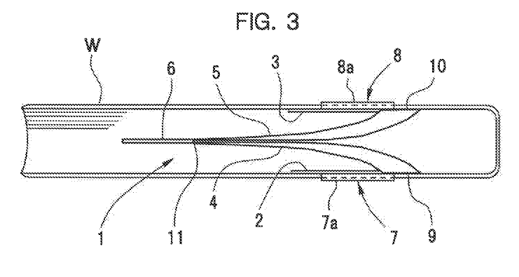

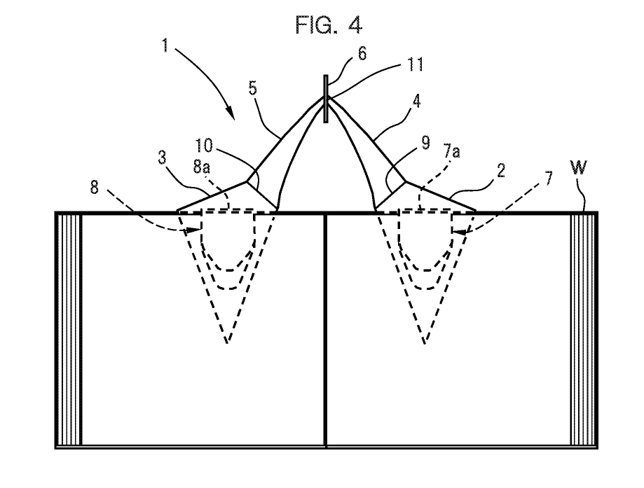

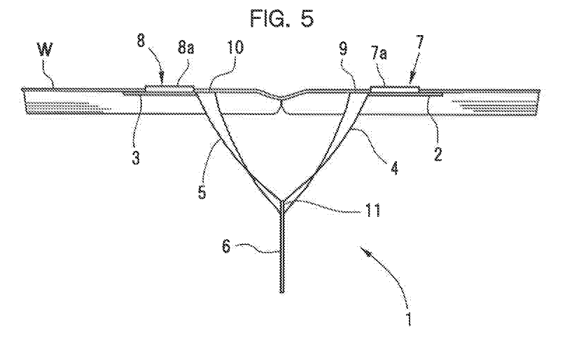

As illustrated in FIG. 2 to FIG. 5, the respective fixing portions 2, 3 have clip portions 7, 8 for holding in-between the respective upper end portions of the front and back covers of a book W or the like. The clip portions 7, 8 sandwich, to thereby fix, the respective front and back covers of a book W or the like each between two tongue pieces formed by bending a metal spring panel so as to overlap each other. In the above, as illustrated in FIG. 2 and FIG. 4, the respective upper edges of the front and back covers abut against the respective straight bending portions 7a, 8a of the clip portions 7, 8, whereby the respective fixing portions 2, 3 can be reliably attached in a predetermined posture.

As illustrated in FIG. 1, the first arm portion 4 and the second arm portion 5 are formed having identical long thin band shapes (symmetrical shapes). This shape is different from the shape of the fixing portions 2, 3. The respective base ends of the arm portions 4, 5 are connected to the fixing portions 2, 3 via hinge portions 9, 10. The respective leading ends of the arm portions 4, 5 are connected to each other via a joint portion 11.

The joint portion 11 is connected to the base end (one end) of the bookmark portion 6. The bookmark portion 6 has a triangular shape whose leading end (the other end) has an acute angle. The bookmark portion 6 does not have a conventional folding line and always remains in a flat panel shape. Since the bookmark portion 6 is formed in a single panel shape without a folding line, the degree of freedom in designing the bookmark portion 6 is high.

The respective hinge portions 9, 10 are folding lines along the boundaries between the fixing portions 2, 3 and the arm portions 4, 5. When the respective fixing portions 2, 3 are fixed to the front and back covers in the predetermined posture mentioned above, the hinge portions 9, 10 are inclined at a predetermined angle θ (see FIG. 2) relative to the upper edges of the front and back covers.

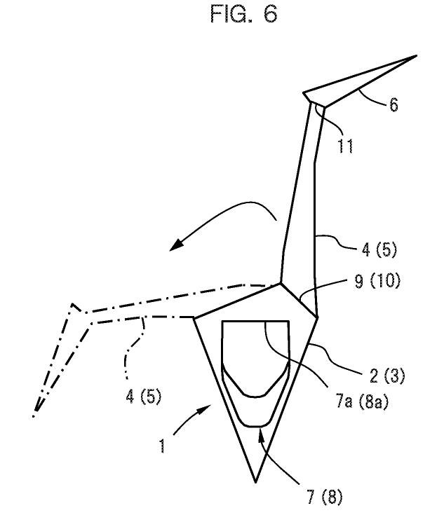

In this embodiment, as illustrated in FIG. 6, the respective folding lines along which the arm portions 4, 5, which extend diagonally upward from the respective upper portions of the rear end portions (the sewed side of a book W or the like) of the fixing portions 2, 3, are folded forward of the respective fixing portions 2, 3 (the open side of a book W or the like), as indicated by the imaginary line in FIG. 6, make the hinge portions 9, 10.

The angle θ of the hinge portions 9, 10 can be desirably set in accordance with the length of the arm portions 4, 5 and the dimension of the bookmark portion 6. The angle θ of the hinge portions 9, 10 in this embodiment is set to 45°, which, however, is not an exclusive example.

As both the hinge portions 9, 10 have the angle θ, the arm portions 4, 5 can swing smoothly. The range for both the arm portions 4, 5 to swing depends on not only the angle θ of the hinge portions 9, 10 but also the angle defined by the open pages of the book W or the length of both the arm portions 4. 5.

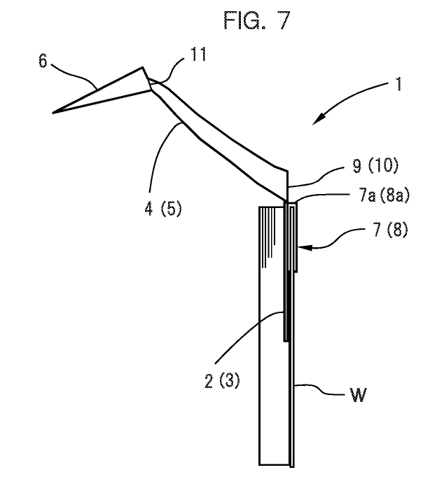

Both the fixing portions 2, 3 move separating from each other along with the motion of the front and back covers when the pages of the book W are being opened. With the fixing portions 2, 3 separating from each other, the arm portions 4, 5 both swing upward of the book W, as illustrated in FIG. 7. With the arm portions 4, 5 swinging, the bookmark portion 6 is lifted upward of the open pages to be retreated there.

When the book W is being closed, both the fixing portions 2, 3 move approaching to each other. Accordingly, both the arm portions 4, 5 swing downward (in the direction approaching the upper edge of the book W), and the bookmark portion 6 is inserted between the closed pages, as illustrated in FIG. 2.

The joint portion 11 stays exposed outside the book W even when the bookmark portion 6 is held between the pages of a book W or the like. With the above, the joint portion 11 is not held between the pages. Hence, the gap between the pages where the bookmark portion is held when the book W is closed is not left wider than necessary.

In a case that both the arm portions 4, 5 are formed having a thin straight band shape, setting the angle θ of the hinge portions 9, 10 to 45° allows both the arm portions 4, 5 to extend substantially parallel to the upper edge of the book W. With the above, the automatic bookmark 1 can remain compact when attached to a book W or the like, so that both the arm portions 4, 5 are not an obstacle, for example, when carrying the book W closed.

The flat bookmark portion 6 of the automatic bookmark 1 of the present embodiment having the above-described structure is held between pages while remaining flat when the book W is closed, and departs from the book W while remaining flat when the book W is being opened. In the above, as both the arm portions 4, 5 can freely flex and the hinge portions 9, 10 have the angle θ, a relatively large swinging angle can be set for both the arm portions 4, 5. With the above, a page being turned less likely touches the bookmark portion 6 retreated above between the open pages of the book W. Should the bookmark portion 6 touch the page, both the arm portions 4, 5 will flex so flexibly that the pages can be turned substantially without resistance.

Although an example has been described in this embodiment in which the first fixing portion 2 is attached to the front cover and the second fixing portion 3 is attached to the back cover, this does not prevent attachment to the sheets constituting the pages of a book W or the like. When the fixing portions 2, 3, are attached to the sheets constituting the pages of a book W or the like, the fixing portions 2, 3 can be used also as a bookmark.

Both the fixing portions 2, 3 can be attached at any desired positions between the front side (the open side) and the far side (the sewed side) of a book W or the like, depending on the thickness of the book W and the limit angle for opening the book W. Specifically, for example, for books W whose pages can be opened up to 180°, attaching both the fixing portions 2, 3 on the far side (closer to the sewed side) of such a book W can make the automatic bookmark 1 usable with the book W. Even in the case, not illustrated, that a book W or the like is viewed with the pages of the book W kept open at 180° or wider, the automatic bookmark 1 is usable without problem as the arm portions 4, 5 rise following the reversing motion of both the fixing portions 2, 3 so as to flexibly follow.

Although an automatic bookmark 1 that is made of paperboard as material is described in this embodiment, the material is not limited to paperboard, and any panel members of materials having appropriate rigidity and flexibility are preferably usable. In this case, such materials may include polypropylenes (PP), polyethylenes (PE), polyethylene terephthalates (PET), polycarbonates (PC), paper reinforced with scotch tape, resin-reinforced thin wood panels, and thin metal plates.

The automatic bookmark 1 can be made in various fashions. The automatic bookmark 1 can be obtained by assembling the fixing portions 2, 3, the arm portions 4, 5, and the bookmark portion 6 as separate parts with adhesive agent, for example. In this case, the respective parts may all be made of the same material, or the respective parts may be made of different materials for every part.

Although not illustrated, the automatic bookmark 1 illustrated in FIG. 1 may be assembled by forming a sheet punched into a desired shape, then forming the bookmark portion 6 in a panel shape through attachment with adhesive agent, and subsequently folding the fixing portions 2, 3 along the folding lines constituting the hinge portions 9, 10, relative to the respective arm portions 4, 5. This fashion makes it possible to assemble the automatic bookmark 1 very easily.

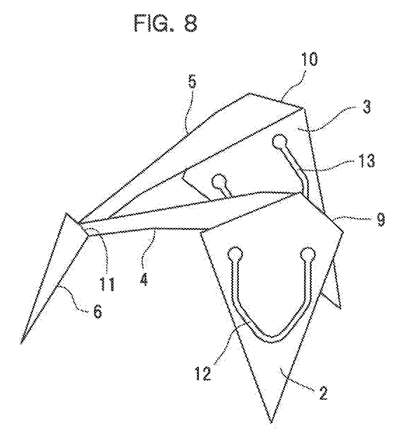

Although an example has been described in this embodiment in which the respective clip portions 7, 8 are provided to the fixing portions 2, 3 to therewith attach the fixing portions 2, 3 to the front and back covers, besides this structure, as illustrated in FIG. 8, clip-like notches 12, 13 may be formed on the fixing portions 2, 3, so that the front and back covers are inserted in the notches 12, 13 whereby the fixing portions 2, 3 are fixed. Alternatively, although not illustrated, instead of the clip portions 7, 8, the respective fixing portions 2, 3 may be fixed to the front and back covers, for example, with a magnet clip, a double stick tape, or adhesive agent, the magnet clip being for fixing with magnets attached on the respective front and back surfaces of a paper sheet.

### DESCRIPTION OF REFERENCE NUMERALS

W . . . book or the like, 1 . . . automatic bookmark, 2 . . . first fixing portion, 3 . . . second fixing portion, 4 . . . first arm portion, 5 . . . second arm portion, 6 . . . bookmark portion, 11 . . . joint portion.

1. An automatic bookmark comprising:
a first fixing portion to be fixed to an upper edge of a front cover of a book;
a second fixing portion to be fixed to an upper edge of a back cover of the book;
a bookmark portion to be positioned closer to an open side of the book than both of the fixing portions are, and to be inserted between closed pages of the book;
a first arm portion whose base end is connected to the first fixing portion and leading end is connected to the bookmark portion; and
a second arm portion whose base end is connected to the second fixing portion and leading end is connected to the bookmark portion,
wherein
in conjunction with separation between the first fixing portion and the second fixing portion, following an opening motion of the book, the first arm portion and the second arm portion swing upward above between open pages of the book, so that the bookmark portion departs from between the pages,
in conjunction with approach between the first fixing portion and the second fixing portion, following a closing motion of the book, the first arm portion and the second arm portion swing, so that the bookmark portion is inserted between closed pages,
a joint portion is provided that connects the first arm portion and the second arm portion to each other via the respective leading ends of the first arm portion and the second arm portion, and
the bookmark portion has a shape whose one end is connected to the joint portion and another end is directed to between the pages of the book.

2. The automatic bookmark according to claim 1, wherein the joint portion is positioned such that the joint portion is exposed outside above the book in a case where the bookmark portion is inserted between the pages of the book.

3. The automatic bookmark according to claim 1, wherein the first arm portion and the second arm portion are in a posture extending along an upper edge of the book in a case where the bookmark portion is inserted between the pages of the book.
